(19) United States
(12) Patent Application Publication
(10) Pub. No.: US 2006/0004829 A1
(43) Pub. Date: Jan. 5, 2006

(54) Rolling keys

(75) Inventors: Simon Robert Walmsley, Balmain (AU); Benjamin David Morphett, Balmain (AU)

Correspondence Address: SILVERBROOK RESEARCH PTY LTD, 393 DARLING STREET, BALMAIN, 2041, AU

(73) Assignee: Silverbrook Research Pty Ltd

(21) Appl. No.: 10/854,513

(22) Filed: May 27, 2004

(51) Int. Cl. G06F 17/00

(52) U.S. Cl. 707/102

(57) ABSTRACT

A method of enabling or disabling a verification process of a first entity in response to a predetermined event, the first entity having at least one associated bit-pattern and at least one variant key, each of the variant keys having been generated by applying a one way function to: a base key; and one or more of the at least one bit-patterns, respectively; or one or more alternative bit patterns, each of the alternative bit-patterns being based on one or the at least one bit-patterns, the method including (a) determining that the predetermined event has happened; and (b) enabling or disabling at least one of the first variant keys in response the predetermined event.

### CO-PENDING APPLICATIONS

Various methods, systems and apparatus relating to the present invention are disclosed in the following co-pending applications filed by the applicant or assignee of the present invention simultaneously with the present application:

| | | | | | |
|---|---|---|---|---|---|
| PLT001US | PLT002US | PLT003US | PLT004US | PLT005US | PLT006US |
| PLT007US | PLT008US | PLT009US | PLT010US | PLT011US | PLT012US |
| PLT013US | PLT014US | PLT015US | PLT016US | PLT017US | PLT018US |
| PLT019US | PLT020US | PLT021US | PLT022US | PLT023US | PLT024US |
| PLT025US | PLT026US | PLT027US | PLT028US | PLT029US | PLT030US |
| PLT031US | PLT032US | PLT033US | | | |

The disclosures of these co-pending applications are incorporated herein by cross-reference. Each application is temporarily identified by its docket number. This will be replaced by the corresponding U.S. Ser. No. when available.

### CROSS-REFERENCES

Various methods, systems and apparatus relating to the present invention are disclosed in the following co-pending applications filed by the applicant or assignee of the present invention. The disclosures of all of these co-pending applications are incorporated herein by cross-reference.

| | | | | |
|---|---|---|---|---|
| 10/727,181 | 10/727,162 | 10/727,163 | 10/727,245 | PEA05US |
| 10/727,233 | 10/727,280 | 10/727,157 | 10/727,178 | 10/72,210 |
| PEA11US | 10/727,238 | 10/727,251 | 10/727,159 | 10/727,180 |
| PEA16US | PEA17US | PEA18US | 10/727,164 | 10/727,161 |
| 10/727,198 | 10/727,158 | 10/754,536 | 10/754,938 | 10/727,227 |
| 10/727,160 | 09/575,108 | 10/727,162 | 09/575,110 | 09/607,985 |
| 6,398,332 | 6,394,573 | 6,622,923 | 10/173,739 | 10/189,459 |
| 10/713,083 | 10/713,091 | ZG164US | 10/713,077 | 10/713,081 |
| 10/713,080 | 10/667,342 | 10/664,941 | 10/664,939 | 10/664,938 |
| 10/665,069 | 09/112,763 | 09/112,762 | 09/112,737 | 09/112,761 |
| 09/113,223 | 09/505,951 | 09/505,147 | 09/505.952 | 09/517,539 |
| 09/517,384 | 09/516,869 | 09/517,608 | 09/517,380 | 09/516,874 |
| 09/517,541 | 10/636,263 | 10/636,283 | ZE028US | ZE029US |
| ZE030US | 10/407,212 | 10/407,207 | 10/683,064 | 10/683,041 |

Some applications have been listed by their docket numbers, these will be replaced when application numbers are known.

### FIELD OF THE INVENTION

The present invention relates to the storage of bit-patterns in non-volatile memory of a device.

The invention has been developed primarily for storing one or more keys in an integrated circuit, and will be described with reference to this application. However, it will be appreciated that the invention can be applied in a number of other fields where it is desirable to store bit-patterns in non-volatile memory.

### BACKGROUND

In embedded applications, it is often necessary to store a secret key in non-volatile memory (such as flash memory on an integrated circuit) in products that are widely distributed.

In certain applications, the same key needs to be stored in multiple integrated circuits, many of which are available to a potential attacker. For example, the integrated circuit can form part of a consumable such as an ink cartridge, which are widely distributed as replacements for empty cartridges.

One way in which an attacker can probe an integrated circuit (or chip) for a key or other secret information is to use a focussed ion beam FIB write attack. In this attack, encapsulant is carefully removed from the circuitry and a FIB used to change one or more bits in flash memory from an unknown state into a known state. Based on the effect the change has on the behaviour of the chip, an attacker may be able to deduce certain information about the state of the attacked bit or bits. For example, if the chip no longer works, it may be determined that the state of the bit or bits was changed by the FIB.

If the chip is disabled by the attack, the attacker merely obtains another chip that has an identical secret key, and attempts a similar attack on a different bit or combination of bits. By repeating the attack on different bits over a number of the chips, the attacker can either directly determine the key, or can build up a statistical model that vastly reduces the number of attempts needed to crack the security offered by the key on the chip. Of course, once the key is compromised in this way, it is compromised for all other chips having this key.

In an ideal world (for the owner of a secret key at least), a given secret key will remain secret forever. However it is prudent to minimise the loss that could occur should a key be compromised.

This is further complicated in a system where all of the components of a system are stored at the user site, potentially without direct connection to a central server that could appropriately update all components after a particular time period or if a compromise is known to have occurred.

### SUMMARY OF THE INVENTION

In a first aspect the present invention provides a method of enabling or disabling a verification process of a first entity in response to a predetermined event, the first entity having at least one associated bit-pattern and at least one variant key, each of the variant keys having been generated by applying a one way function to: a base key; and one or more of the at least one bit-patterns, respectively; or one or more alternative bit patterns, each of the alternative bit-patterns being based on one or the at least one bit-patterns, the method including the method including:

(a) determining that the predetermined event has happened; and

(b) enabling or disabling at least one of the first variant keys in response the predetermined event.

Optionally step (a) includes disabling at least one of the variant keys, such that the disabled at least one variant key can no longer be used to digitally sign information in that entity.

Optionally step (a) includes disabling at least one of the variant keys, such that the disabled at least one variant key can no longer be used to verify information signed by one or more respective base keys related to the disabled at least one variant key in that entity.

Optionally the step of disabling the at least one variant key includes modifying a status of a flag associated with that at least one variant key.

Optionally the step of disabling the at least one variant key includes deleting that at least one variant key.

Optionally the step of disabling the at least one variant key includes modifying that at least one variant key

Optionally the event is a predetermined point in time being reached or passed.

Optionally the first entity includes a plurality of the variant keys, the plurality of variant keys being based on the result of a one way function applied to: a respective one of a corresponding plurality of base keys; and one of the at least one bit-patterns or one of the at least one alternative bit-patterns, the method including the steps of:

determining that a predetermined event related to one of the variant keys has happened; and

enabling or disabling at least one of the plurality of variant keys with which the predetermined event is associated.

Optionally the plurality of base keys has a corresponding sequence of predetermined events associated with them, the method including the steps of:

(a) determining that one of the predetermined event has happened; and

(b) enabling or disabling the variant key in the sequence corresponding to predetermined event that is determined to have happened.

Optionally the variant keys are disabled in the order of the sequence of predetermined events.

Optionally the sequence of events is chronological.

Optionally each of the events includes a time being reached.

Optionally the step of determining that one of the events has happened includes receiving a time from a trusted source.

Optionally the time is a date.

Optionally the date is determined with a resolution of a month.

Optionally the predetermined event includes detection of compromise of one or more of the keys, the method including disabling the one or more variant keys corresponding to the one or more keys that were compromised.

Optionally the predetermined event includes suspect compromise of one or more of the keys, the method including disabling the one or more variant keys corresponding to the one or more keys that were suspected of being compromised.

In a further aspect the present invention provides a method of manufacturing second entities for use in the verification process with the first entity of claim 1, each of the first entities including at least first and second variant key, the first variant key having been generated by applying a one way function to a first base key and a first bit-pattern, and the second variant key having been generated by applying a one way function to a second base key and a second bit-pattern, the method comprising the steps of:

manufacturing a plurality of second entities for use with the first entities, each of the second entities including at least the first base key; and

upon the first variant key being disabled in response to one of the predetermined event, manufacturing a plurality of third entities for use with the first entities, each of the third entities including at least the second base key.

Optionally the first variant key is automatically disabled in response to a predetermined event.

Optionally the method further includes the step of causing the first variant key to be disabled.

Optionally the first variant key is disabled in response to a time being reached.

Optionally at least some of the first entities have one or more further variant keys, each of the respective further variant keys having been generated by applying a one way function to respective further base keys and bit-patterns, each of the variant keys being enabled or disabled in response to respective predetermined events, the method comprising the step of manufacturing a sequence of sets of second entities, each set of the second entities being manufactured such that the variant key corresponding to its base key is enabled for the verification process during the life of that set.

Optionally the predetermined events are selected such that the variant keys corresponding with the base keys of more than one of the sets are enabled at once.

Optionally there is provided a method using a first entity configured to authenticate a digital signature supplied by a second entity, wherein one of the entities includes a base key and the other of the entities includes a variant key and a bit-pattern, the variant key being based on the result of applying a one way function to the base key and the bit-pattern, the digital signature having been generated by the second entity using its key to digitally signing at least part of data to be authenticated, the first entity being configured to:

(a) receive the digital signature from the second entity;

(b) receive the data; and

(c) authenticate the digital signature based on the received data and the first entity's key.

Optionally there is provided a method using a first entity including:
a first bit-pattern
a non-volatile memory storing resource data,
   a first base key for use with at least a first variant key;
   a second variant key for use with a second base key, the second variant key being the result of a one way function applied to: the second base key; and the first bit-pattern or a modified bit-pattern based on the first bit-pattern.

Optionally there is provided a method using a system for enabling authenticated communication between a first entity and at least one other entity, the system including a second entity, wherein:
the first entity and the second entity share transport keys; and
the second entity includes at least one authentication key configured to be transported from the second entity to the first entity using the transport keys, the authentication key being usable to enable the authenticated communication by the first entity.

Optionally there is provided a method including storing a first bit-pattern in non-volatile memory of a device, the method comprising:

(a) applying a one way function to a second bit-pattern associated with the device, thereby to generate a first result;

(b) applying a second function to the first result and the first bit-pattern, thereby to generate a second result; and

(c) storing the second result in the memory, thereby indirectly storing the first bit-pattern.

Optionally there is provided a method including storing a bit-pattern in each of a plurality of devices, each of the devices having a memory, the method comprising, for each device:

(a) determining a first memory location; and

(b) storing the bit-pattern at the first memory location;
wherein the first memory locations are different in at least a plurality of the respective devices.

Optionally there is provided a method including storing at least one functionally identical code segment in each of a plurality of devices, each of the devices having a memory, the method comprising, for each device:

(a) determining a first memory location; and

(b) storing a first of the at least one code segments in the memory at the first memory location;

wherein the first memory location is different in at least a plurality of the respective devices.

Optionally there is provided a method including providing a sequence of nonces (R0, R1, R2, . . . ) commencing with a current seed of a sequence of seeds (×1, ×2, ×3, . . . ), the method comprising:

(a) applying a one-way function to the current seed, thereby to generate a current nonce;

(b) outputting the current nonce;

(c) using the current seed to generate a next seed in a sequence of seeds, the seed so generated becoming the current seed; and

(d) repeating steps (a) to (c) as required to generate further nonces in the sequence of nonces.

Optionally there is provided a method including storing multiple first bit-patterns in non-volatile memory of a device, the method comprising, for each of the first bit-patterns to be stored:

(a) applying a one way function to a third bit-pattern based on a second bit-pattern associated with the device, thereby to generate a first result;

(b) applying a second function to the first result and the first bit-pattern, thereby to generate a second result; and

(c) storing the second result in the memory, thereby indirectly storing the first bit-pattern;
wherein the third bit-patterns used for the respective first bit-patterns are relatively unique compared to each other.

Because the nonce is generated by a one-way function, the exported sequence, R₀, R₁, R₂, R₃, . . . etc., is not predictable (or deterministic) from an attacker's point of view. It is computationally difficult to predict the next number in the sequence.

The advantages of this approach are:
The calculation of the next seed, and the generation of a nonce from the seed are not computationally difficult.
A true non-deterministic number is only required once, during entity instantiation. This moves the cost and complexity of the difficult generation process out of the entity. There is no need for a source of random numbers from a non-deterministic physical process in the running system.

Note that the security of this sequence generation system relies on keeping the current value for x secret. If any of the x values is known, then all future values for x can be predicted and hence all future R values can be known.

Note that the random sequence produced from this is not a strong random sequence e.g. from the view of guaranteeing particular distribution probabilities. The behaviour is more akin to random permutations. Nonetheless, it is still useful for the purpose of generating a sequence for use as a nonce in such applications as a SoC-based [3] implementation of the QA Logical Interface [4].

### STORAGE OF FUNCTIONALLY IDENTICAL CODE SEGMENT IN MULTIPLE CHIPS

In one embodiment, functionally identical code segments are stored in each of multiple devices. The device can be, for example, a series of printer cartridges, and more specifically the QA printer chip attached to such cartridges.

The programs stored in the devices are functionally identical to each other, which is to say that they implement the same instructions in the same way, although the individual instances of the programs may operate on different data and using different keys.

Whilst the program instances are functionally identical, they are broken up into code segments that are each stored at different locations in the flash memory. For convenience, each code segment can be a function or other relatively self-contained subset of instructions, although this is not required.

After the chip has been manufactured, the program code is injected such that the position of particular code segments varies across the devices. The memory location at which each code segment starts can be selected in any convenient manner. It is not strictly necessary that every segment be placed in a truly random or unique location in the memory from device to device. Rather, it is enough that a potential attacker cannot rely on the same code being in the same place in a series of different integrated circuits.

It is still, however, desirable that the location of particular code segments be selected at least pseudo-randomly, and preferably randomly.

In the preferred embodiment, an initial instruction is located at an initial memory location that is the same across all of the devices. This means that a common boot program can be used at startup, since it always looks to the initial location to commence the program. Somewhere in the code segment following the initial location, the program jumps to one of the random or pseudo-random memory locations. From this point in the program, the instructions are effectively unknown to an attacker. Of course, it is possible that only a relatively small (but preferably important) code section is located at this random or pseudo-random location. The rest of the code can be at common locations across the devices.

The reference to the random or pseudo-random location in the program code can be explict (as above) or implicit. For example, the program code can refer to a pointer or register that contains the location of interest. The location is stored in the pointer or register during program instantiation. The location of interest can also be stored in a jump table.

Multiple random or pseudo random locations can be used. The program can jump to multiple locations during its execution, each of the locations being different across several devices. The code segments themselves can be different to each other, such that even the segments themselves (in number or size) vary from device to device.

Terms: A number of terms are used in the specification and claims. The following list includes some definitions that are to be used when these terms appear, unless a contrary meaning is clearly intended in context:

“Relatively unique”—Depending upon the context, this phrase generally means that a value or bit-pattern is rarely repeated across multiple devices. It is usually preferable that the value or bit-pattern is selected in a random or at least psuedo-random way. However, in some applications it is sufficient to ensure that the value or bit-pattern is merely not frequently repeated from device to device. Sometimes, a relatively small number of potential values or bit-patterns will be sufficient to make attacking a chip or other device sufficiently hard that it will not be worth attempting

“Associated with a base key”—A variant key is associated with a base key when it is the result of applying a one way function to the base key and a bit-pattern.

“Cryptographically strong”—Whilst this is a relative term, it has some use when comparing the ease with which functions can be broken when used in cryptography. For example, an XOR function, whilst useful in some circumstances in cryptography, is considerably easier to “crack” than, say, a hash function or sufficient length.

Also, a hash function combined with a key into a MAC (i.e. “message authentication code”) such as HMAC-SHA1 used with a certain length of key will be cryptographically stronger if the key length is increased, up to a certain length of key.

“Bit-pattern”—A generic term that can refer to keys, nonces, random numbers, pseudo-random numbers, serial numbers, and any other strings of interest.

“Functionally identical”—Code segments that are functionally identical operate in the same way, using the same functions and subroutines as each other where each of the functions and subroutines are also functionally identical. However they may use different keys, constants or variables, and/or operate on different stored data or data and program segment code stored at different locations in memory. For example, two functionally identical code segments may each load a particular constant into a register for use in evaluating an expression, and although the order of steps taken to load the constant may differ between segments, the value of the constant may differ between segments, and the address of the constant in memory may differ between segments, the functional intent of the code segment is the same for both.

It will be appreciated by those skilled in the art that the foregoing represents only a preferred embodiment of the present invention. Those skilled in the relevant field will immediately appreciate that the invention can be embodied in many other forms.

1. A method of enabling or disabling a verification process of a first entity in response to a predetermined event, the first entity having at least one associated bit-pattern and at least one variant key, each of the variant keys having been generated by applying a one way function to: a base key; and one or more of the at least one bit-patterns, respectively; or one or more alternative bit patterns, each of the alternative bit-patterns being based on one or the at least one bit-patterns, the method including the method including:
(a) determining that the predetermined event has happened; and
(b) enabling or disabling at least one of the first variant keys in response the predetermined event.

2. A method according to claim 1, wherein step (a) includes disabling at least one of the variant keys, such that the disabled at least one variant key can no longer be used to digitally sign information in that entity.

3. A method according to claim 1, wherein step (a) includes disabling at least one of the variant keys, such that the disabled at least one variant key can no longer be used to verify information signed by one or more respective base keys related to the disabled at least one variant key in that entity.

4. A method according to claim 1, wherein the step of disabling the at least one variant key includes modifying a status of a flag associated with that at least one variant key.

5. A method according to claim 1, wherein the step of disabling the at least one variant key includes deleting that at least one variant key.

6. A method according to claim 1, wherein the step of disabling the at least one variant key includes modifying that at least one variant key

7. A method according to claim 1, wherein the event is a predetermined point in time being reached or passed.

8. A method according to claim 1, wherein the first entity includes a plurality of the variant keys, the plurality of variant keys being based on the result of a one way function applied to: a respective one of a corresponding plurality of base keys; and one of the at least one bit-patterns or one of the at least one alternative bit-patterns, the method including the steps of:
determining that a predetermined event related to one of the variant keys has happened; and enabling or disabling at least one of the plurality of variant keys with which the predetermined event is associated.

9. A method according to claim 1, wherein the plurality of base keys has a corresponding sequence of predetermined events associated with them, the method including the steps of:
(a) determining that one of the predetermined event has happened; and
(b) enabling or disabling the variant key in the sequence corresponding to predetermined event that is determined to have happened.

10. A method according to claim 9, wherein the variant keys are disabled in the order of the sequence of predetermined events.

11. A method according to claim 10, wherein the sequence of events is chronological.

12. A method according to claim 11, wherein each of the events includes a time being reached.

13. A method according to claim 12, wherein the step of determining that one of the events has happened includes receiving a time from a trusted source.

14. A method according to claim 13, wherein the time is a date.

15. A method according to claim 14, wherein the date is determined with a resolution of a month.

16. A method according to claim 2, wherein the predetermined event includes detection of compromise of one or more of the keys, the method including disabling the one or more variant keys corresponding to the one or more keys that were compromised.

17. A method according to claim to claim 2, wherein the predetermined event includes suspect compromise of one or more of the keys, the method including disabling the one or more variant keys corresponding to the one or more keys that were suspected of being compromised.

18. A method of manufacturing second entities for use in the verification process with the first entity of claim 1, each of the first entities including at least first and second variant key, the first variant key having been generated by applying a one way function to a first base key and a first bit-pattern, and the second variant key having been generated by applying a one way function to a second base key and a second bit-pattern, the method comprising the steps of:
manufacturing a plurality of second entities for use with the first entities, each of the second entities including at least the first base key; and
upon the first variant key being disabled in response to one of the predetermined event, manufacturing a plurality of third entities for use with the first entities, each of the third entities including at least the second base key.

19. A method according to claim 1, wherein the first variant key is automatically disabled in response to a predetermined event.

20. A method according to claim 19, further including the step of causing the first variant key to be disabled.

21. A method according to claim 20, wherein the first variant key is disabled in response to a time being reached.

22. A method according to claim 16, wherein at least some of the first entities have one or more further variant keys, each of the respective further variant keys having been generated by applying a one way function to respective further base keys and bit-patterns, each of the variant keys being enabled or disabled in response to respective predetermined events, the method comprising the step of manufacturing a sequence of sets of second entities, each set of the second entities being manufactured such that the variant key corresponding to its base key is enabled for the verification process during the life of that set.

23. A method according to claim 22, wherein the predetermined events are selected such that the variant keys corresponding with the base keys of more than one of the sets are enabled at once.

24. A method according to claim 1, using a first entity configured to authenticate a digital signature supplied by a second entity, wherein one of the entities includes a base key and the other of the entities includes a variant key and a bit-pattern, the variant key being based on the result of applying a one way function to the base key and the bit-pattern, the digital signature having been generated by the second entity using its key to digitally signing at least part of data to be authenticated, the first entity being configured to:
(a) receive the digital signature from the second entity;
(b) receive the data; and
(c) authenticate the digital signature based on the received data and the first entity's key.

25. A method according to claim 1, using a first entity including:
a first bit-pattern
a non-volatile memory storing resource data,
a first base key for use with at least a first variant key;
a second variant key for use with a second base key, the second variant key being the result of a one way function applied to: the second base key; and the first bit-pattern or a modified bit-pattern based on the first bit-pattern.

26. A method according to claim 1, using a system for enabling authenticated communication between a first entity and at least one other entity, the system including a second entity, wherein:
the first entity and the second entity share transport keys; and
the second entity includes at least one authentication key configured to be transported from the second entity to the first entity using the transport keys, the authentication key being usable to enable the authenticated communication by the first entity.

27. A method according to claim 1, including storing a first bit-pattern in non-volatile memory of a device, the method comprising:
(a) applying a one way function to a second bit-pattern associated with the device, thereby to generate a first result;
(b) applying a second function to the first result and the first bit-pattern, thereby to generate a second result; and
(c) storing the second result in the memory, thereby indirectly storing the first bit-pattern.

28. A method according to claim 1, including storing a bit-pattern in each of a plurality of devices, each of the devices having a memory, the method comprising, for each device:
(a) determining a first memory location; and
(b) storing the bit-pattern at the first memory location;
wherein the first memory locations are different in at least a plurality of the respective devices.

29. A method according to claim 1, including storing at least one functionally identical code segment in each of a plurality of devices, each of the devices having a memory, the method comprising, for each device:
(a) determining a first memory location; and
(b) storing a first of the at least one code segments in the memory at the first memory location;
wherein the first memory location is different in at least a plurality of the respective devices.

30. A method according to claim 1, including providing a sequence of nonces (R0, R1, R2, . . . ) commencing with a current seed of a sequence of seeds (×1, ×2, ×3, . . .), the method comprising:
(a) applying a one-way function to the current seed, thereby to generate a current nonce; (b) outputting the current nonce;
(c) using the current seed to generate a next seed in a sequence of seeds, the seed so generated becoming the current seed; and
(c) repeating steps (a) to (c) as required to generate further nonces in the sequence of nonces.

31. A method according to claim 1, including storing multiple first bit-patterns in non-volatile memory of a device, the method comprising, for each of the first bit-patterns to be stored:
(a) applying a one way function to a third bit-pattern based on a second bit-pattern associated with the device, thereby to generate a first result;
(b) applying a second function to the first result and the first bit-pattern, thereby to generate a second result; and
(c) storing the second result in the memory, thereby indirectly storing the first bit-pattern;
wherein the third bit-patterns used for the respective first bit-patterns are relatively unique compared to each other.
